(19) United States
(12) Patent Application Publication
(10) Pub. No.: US 2008/0078865 A1
(43) Pub. Date: Apr. 3, 2008

(54) Unmanned Sensor Placement In A Cluttered Terrain

(75) Inventor: Richard A. Burne, Ellicott City, MD (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/534,059

(22) Filed: Sep. 21, 2006

(51) Int. Cl. B64D 45/00

(52) U.S. Cl. 244/1 R

(57) ABSTRACT

An Unattended Ground Sensor (UGS) is accurately placed in a cluttered environment by using a vertical take-off and landing vehicle (VTOL). The VTOL maneuvers to a drop point, and hovers over or lands at the drop point. The VTOL deploys the UGS and provides the UGS with its position. Additionally, the VTOL may monitor the drop point before and after the deployment to verify drop point conditions and UGS functionality.

### FIELD

The present invention relates generally to unattended ground sensors, and more particularly, relates to the placement of these sensors in a cluttered terrain.

### BACKGROUND

An Unattended Ground Sensor (UGS) is an unmanned monitoring station often used for military surveillance, troop movement detection, and target identification. The UGS may include one or more sensors, such as a magnetic sensor, a seismic sensor, an acoustic sensor, an optical sensor, or a chemical sensor. The UGS may transmit sensor data to a field command unit for analysis and use in various field operations. Typically, this sensor data is transmitted via a terrestrial or satellite radio link.

The UGS is typically deployed in the field by hand placement or via an airdrop. For many, if not all, operations using data from a UGS, knowing the precise location of the UGS is critical. Thus, if the UGS is deployed by hand, the UGS placement may be accurately determined using surveying techniques or with a hand-held global positioning satellite (GPS) unit. If the UGS is deployed via airdrop, the UGS typically includes additional navigation and/or positioning equipment to determine its location.

There are many situations in which hand deployment of the UGS is not feasible. For example, the terrain may be too difficult to reach by foot, such as in a mountainous region. As another example, the area to be monitored may be hostile and too dangerous for personnel to deploy the UGS. In these situations, air deployment of the UGS is preferred.

A UGS designed for air deployment may include position determining equipment, such as a GPS unit, designed to determine the precise location of the UGS after airdrop completion. However, this position determining equipment may increase the cost and size of the UGS. This increase in cost and/or size may impact whether the UGS can be used in some operations. Moreover, the position determining equipment may not work properly in a cluttered environment.

Additionally, it may be difficult for an aircraft to successfully reach the intended drop location of the UGS in cluttered environments. For example, after the aircraft has released the UGS, trees or buildings may stop and/or deflect the descending UGS. As a result, the UGS may not reach the ground surface or land in an unintended location. If the UGS is not successfully deployed, the UGS may not properly function to sense and transmit sensor data back to the command center.

Thus, it would be beneficial to provide an improved method of placing a UGS in a cluttered terrain.

### SUMMARY

A method for unmanned sensor placement in a cluttered terrain is described. The method includes maneuvering an unmanned aerial vehicle having position determining equipment to a drop point; determining a location of the unmanned aerial vehicle with the position determining equipment; dropping or placing a device from the unmanned aerial vehicle; and providing the device with the location of the unmanned aerial vehicle. The unmanned aerial vehicle may be a vertical take-off and landing vehicle, the position determining equipment may be a global positioning satellite unit, and the device may an unattended ground sensor, a computing device, or a communication device. The drop point may be in a cluttered area.

Providing the device the location of the unmanned aerial vehicle may include transmitting the location to the device via a wireless communication link. Dropping the device from the unmanned aerial vehicle may include hovering over the drop point. Placing the device may include detaching the device from a landed unmanned aerial vehicle.

The method may also include evaluating the drop point prior to dropping or placing the device. Evaluating the drop point may include the unmanned aerial vehicle obtaining an image of the drop point and transmitting the image to a remote location where the image can be evaluated.

The method may also include evaluating the device after dropping or placing the device. Evaluating the device may include verifying that the device is properly placed in the ground surface. Evaluating the device may also include verifying the functionality of the device.

The method may also include the device sending data to the unmanned aerial vehicle. The method may also include the unmanned aerial vehicle reprogramming the device.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a pictorial representation of an airdrop of a UGS in a cluttered area, according to an example; and

FIG. 2 is a flow diagram of a method for air deployment of a UGS, according to an example.

### DETAILED DESCRIPTION

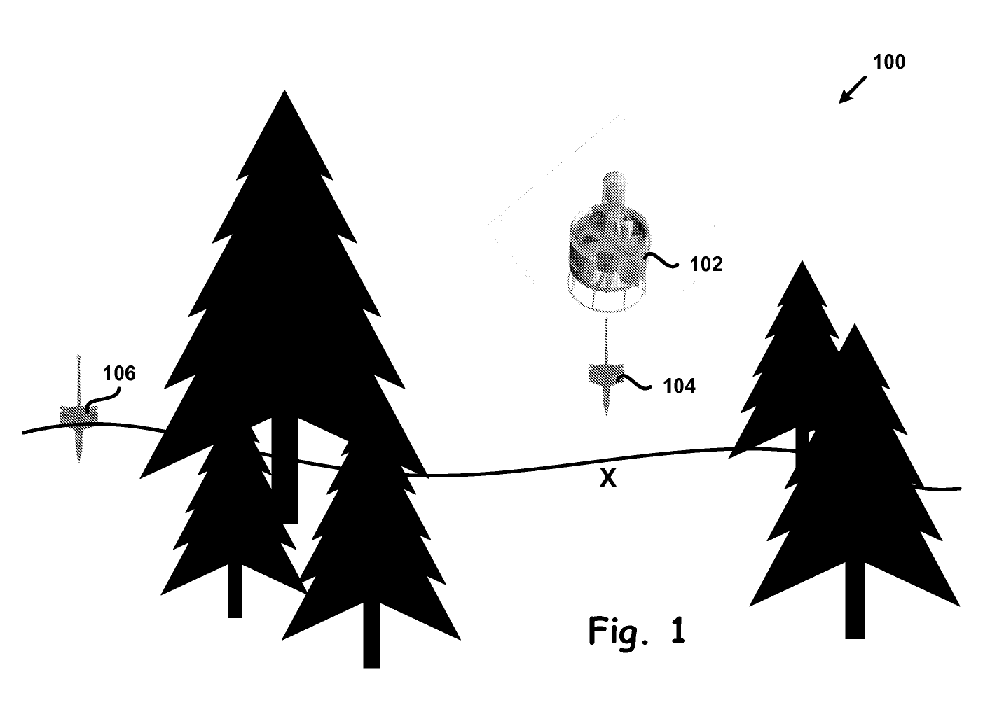

FIG. 1 is a pictorial representation of an airdrop of a UGS 104 in a cluttered area 100. In this example, the cluttered area 100 is a wooded area, such as a forest, and trees may impede the airdrop of the UGS 104. It is understood, however, that the invention is not limited to any particular type of cluttered environment. For example, the environment may be cluttered with buildings, rocks, or any other obstacle or combination of obstacles.

The UGS 104 may have one or more sensors designed to detect one or more conditions. For example, the UGS 104 may include a magnetic sensor, a seismic sensor, an acoustic sensor, an optical sensor, and/or a chemical sensor. The type of sensor or sensors included in the UGS 104 may depend on the type of mission for which the UGS 104 is to be deployed. The UGS 104 may also include a radio and antenna for transmitting sensor data to a command center or other appropriate location. The UGS 104 may also include other devices as well, such as a power supply.

The UGS 104 may be formed to have a variety of shapes, configurations, geometries, and textures which are suitable for air deployment. For example, the UGS 104 may have a housing that protects the sensors during and after deployment. Additionally, the UGS 104 may have a penetrating tip member that is designed to penetrate the ground surface. The UGS 104 may include other parts, such as a stop plate for preventing the housing from penetrating too far into the ground and aerial fins for stability. It is understood, however, that the invention is not limited to any particular type of UGS.

The UGS 104 is airdropped from or placed by a vertical take-off and landing vehicle (VTOL) 102. The VTOL 102 may also deploy other devices, such as a processing unit or other computational device that needs to know its location relative to other devices. For example, the device may be a gateway device that receives information from several sensors, correlates the sensor data, and sends the correlated data to the command center. As another example, the device may be a communication relay device.

The VTOL 102 may be an unmanned aerial vehicle. An unmanned aerial vehicle is a remotely piloted or self-piloted aircraft that can carry cameras, sensors, communications equipment, and/or other payloads. Preferably, the VTOL 102 has a ducted fan platform. For example, the VTOL 102 may be a Micro Air Vehicle (MAV) or an Organic Air Vehicle (OAV). It is understood, however, that the invention is not limited to any particular type of VTOL.

The VTOL 102 has the ability to maneuver among trees, buildings, and other obstacles. Additionally, the VTOL 102 has the ability to hover. Thus, the VTOL 102 can maneuver to a desired drop point (depicted as “X” in FIG. 1), descend to a desired height above the drop point, and then drop the UGS 104 while hovering over the drop point. The VTOL 102 also has the ability to land and takeoff, which allows the VTOL 102 to deploy the UGS 104 by landing and detaching the UGS 104 at the drop point. As a result, the UGS 104 or other device may be deployed in a location that would not be possible with hand placement or traditional air deployment.

Additionally, the VTOL 102 may have downward image capability. For example, the VTOL 102 may include a visible light and/or infrared video camera. As a result, the VTOL 102 may obtain an image of the desired drop location prior to dropping the UGS 104. The image may be transmitted to the command center where the operation is being remotely monitored. The image may also be remotely monitored in the field on portable laptop computers, handheld terminal units, soldier-wearable computers, vehicle-mounted computers, and so on.

Based on the transmitted image, an operation commander or other appropriate personnel may either authorize the airdrop operations to proceed as planned or change the plan. If there is a problem with the planned drop point, the commander may abort the operation altogether or have the VTOL 102 maneuver in the cluttered area 100 to find a new drop point. For example, the planned drop point may have a rock obstructing placement. If airdropped above the rock, the UGS 104 may bounce off the rock, break, or otherwise not deploy properly. By instructing the VTOL 102 to maneuver away from the rock, the UGS 104 may be properly deployed.

After the UGS 104 is deployed and positioned in the ground surface, the VTOL 102 may transmit its position to the UGS 104 so that the UGS 104 “knows” its position. The VTOL's position may be determined using on-board GPS, navigation, altimeter, and/or other avionic systems at or near the time of deployment. As the VTOL 102 is able to maneuver to the intended drop point, and hover over or land at the drop point during the deployment, the VTOL's position is an accurate representation of the position of the UGS 104.

The VTOL 102 and the UGS 104 may communicate via a first communication link. The UGS 104 and the command center may communicate via a second communication link, which may be the same or different than the first communication link. The first and second communication links may be a wireless commercial and/or military communication link, now known or developed in the future. For example, the communication links may be an ultra-wideband communication link, an 802.11 communication link, or a Link 16 data link, which is a military inter-computer data exchange format of the North American Treaty Organization (NATO).

The downward image capability of the VTOL 102 may also be used after deployment to determine whether the UGS 104 has properly impaled in the ground surface. For example, the VTOL 102 hovering over the previously deployed UGS 106 may send an image to the command center that confirms that the UGS 106 is properly placed in the ground surface.

The VTOL 102 may also be used to determine the functionality of the UGS 104 after its deployment. The VTOL 102 may maneuver in the surrounding area to determine if there are any obstacles that may impede the ability of the UGS 104 to collect and/or transmit data. For example, if there is a video camera on the UGS 104 and the UGS 104 is deployed near a rock, the video camera may be unable to obtain useful images in the direction of the rock. As another example, if there is an acoustic sensor on the UGS 104 and the UGS 104 is deployed near a wall, the acoustic sensor may not sense sounds emanating from the far side of the wall. These obstacles may also impact the ability of the UGS 104 to transmit data to the command center.

By understanding the environment of the sensor, the operations commander may be better prepared to make decisions. For example, based on the location of the UGS 104 within the cluttered area 100, the commander can map the functionality of the sensor. This mapping may include all of the unmanned sensors in the cluttered area 100 to depict a coverage area. The map may then be used to identify areas that are not covered by currently deployed sensors, and may be used to plan additional deployments of unmanned sensors.

While the communication between the VTOL 102 and the UGS 104 has been described at the time of deployment, communication between the VTOL 102 and the UGS 104 may also occur after deployment. For example, in addition to transmitting sensor data to the command center, the UGS 104 may also store data over time. Some time after deployment, the UGS 104 may communicate the stored data to the VTOL 102. As another example, the VTOL 102 may reprogram the UGS 104 for a new mission. As a result, a subsequent deployment may be avoided, saving time and money.

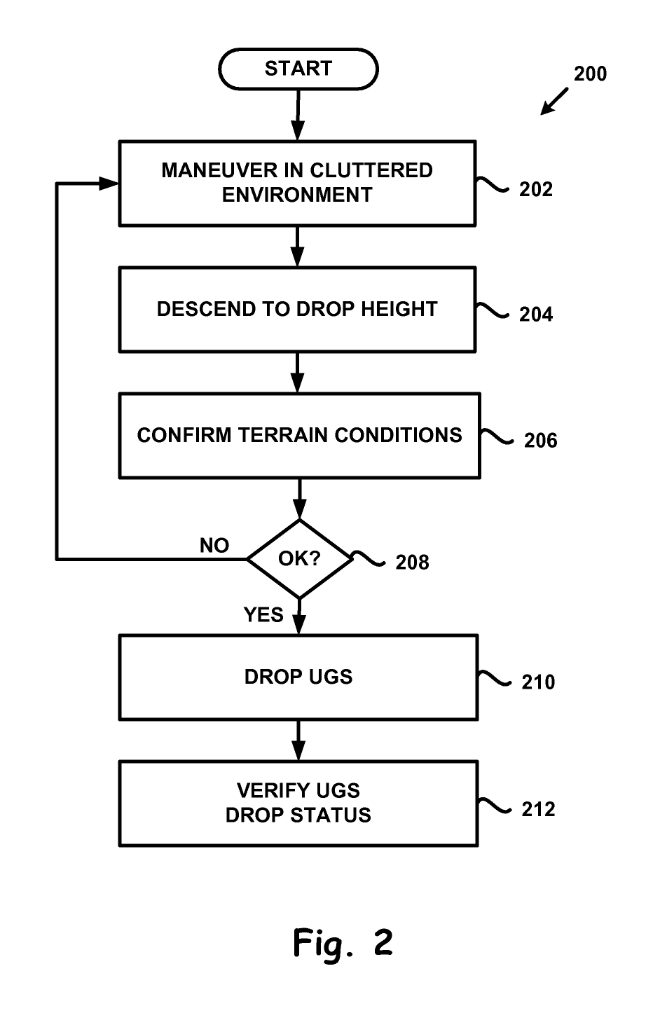

FIG. 2 is a flow diagram 200 of a method for air deployment of the UGS 104. At block 202, the VTOL 102 maneuvers in the clutter area 100. The VTOL 102 has the UGS 104 in its payload. The VTOL 102 maneuvers to the planned drop point and, at block 204, descends to the drop height. The drop height may be the height above ground level that is optimal for sensor deployment, while allowing the VTOL 102 to maintain its GPS link.

At block 206, the VTOL 102 may transmit images of the planned drop point to the command center. Additionally or alternatively, the VTOL 102 may transmit images of the drop point prior to descending to the drop height. The operations commander may view the images and determine whether the drop point is acceptable for deploying the UGS 104. If the drop point is acceptable, at block 210, the UGS 104 is dropped from the VTOL 102. Alternatively, the VTOL 102 may land at the drop point and detach the UGS 104. Otherwise, the operations commander may instruct the VTOL 102 to continue maneuvering in the cluttered area 100 to find a different drop point or to abort the airdrop.

At block 212, the drop status of the UGS 104 is verified. In addition to verifying that the UGS 104 was properly deployed, the functional status of the UGS 104 may also be determined. To verify the drop status of the UGS 104, the VTOL 102 may transmit images of the deployed UGS 104 and the surrounding area to the command center. Additionally, by establishing a communication link with the UGS 104, the VTOL 102 may ascertain sensor functionality after deployment and provide the UGS 104 with its GPS position.

By using the VTOL 102 to place the UGS 104 in the cluttered terrain 100, the UGS 104 may be accurately placed in a location that is not feasible by hand placement or conventional airdrop techniques. Moreover, the UGS 104 may receive accurate position information from the VTOL 102 eliminating the need to include position determining equipment in the UGS 104, which may not work in the cluttered environment 100. As a result, the accurately placed UGS 104 can obtain and transmit sensor data to a remote location for assessment.

While the terms command center and operations commander were used throughout the description, it is understood that the UGS 104 may be used for applications other than military operations. For example, the UGS 104 may be used to monitor wildlife, seismic activity, trespassers, and so on. As another example, the UGS 104 may be used by civilian police forces. Thus, these terms apply to any locations and personnel that are appropriate for monitoring the UGS 104.

It should be understood that the illustrated embodiments are examples only and should not be taken as limiting the scope of the present invention. For example, the invention may be used in an uncluttered area. Additionally, as described above, the invention may be used to place devices other than a UGS, such as a computing device or communication device.

The claims should not be read as limited to the described order or elements unless stated to that effect. Therefore, all embodiments that come within the scope and spirit of the following claims and equivalents thereto are claimed as the invention.

I claim:

1. A method for placing a device, comprising in combination:
maneuvering an unmanned aerial vehicle having position determining equipment to a drop point;
determining a location of the unmanned aerial vehicle with the position determining equipment;
deploying a device from the unmanned aerial vehicle; and
providing the device with the location of the unmanned aerial vehicle.

2. The method of claim 1, wherein the unmanned aerial vehicle is a vertical take-off and landing vehicle.

3. The method of claim 1, wherein the position determining equipment includes a global positioning satellite unit.

4. The method of claim 1, wherein the device is one of an unattended ground sensor, a computing device, and a communication device.

5. The method of claim 1, wherein the drop point is in a cluttered area.

6. The method of claim 1, wherein deploying the device includes dropping the device from the unmanned aerial vehicle while the unmanned aerial vehicle is hovering over the drop point.

7. The method of claim 1, wherein deploying the device includes detaching the device from the unmanned aerial vehicle after the vehicle has landed.

8. The method of claim 1, wherein providing the device the location of the unmanned aerial vehicle includes transmitting the location to the device via a wireless communication link.

9. The method of claim 1, further comprising evaluating the drop point prior to deploying the device.

10. The method of claim 9, wherein evaluating the drop point includes the unmanned aerial vehicle obtaining an image of the drop point and transmitting the image to a remote location where the image can be evaluated.

11. The method of claim 1, further comprising evaluating the device after deploying the device.

12. The method of claim 11, wherein evaluating the device includes verifying that the device is properly placed in a ground surface.

13. The method of claim 11, wherein evaluating the device includes verifying functionality of the device.

14. The method of claim 1, further comprising the device sending data to the unmanned aerial vehicle.

15. The method of claim 1, further comprising the unmanned aerial vehicle reprogramming the device.

16. A method for placing a device, comprising in combination:
maneuvering in a cluttered environment to a drop height above a drop point;
confirming terrain conditions;
deploying a device if the terrain conditions are suitable; and
providing the device with location information that identifies the device's position in the cluttered environment.

17. The method of claim 16, further comprising verifying operational capabilities of the device after deploying the device.

18. The method of claim 16, wherein an unmanned aerial vehicle maneuvers in the cluttered environment.

19. The method of claim 16, wherein confirming terrain conditions includes obtaining an image of the terrain conditions and transmitting the image to a remote location where the image can be evaluated.

20. The method of claim 16, wherein the device is one of an unattended ground sensor, a computing device, and a communication device.

21. The method of claim 16, wherein providing the device with location information includes providing the device with a location of a vehicle dropping the device.
